(19) United States
(12) Patent Application Publication
(10) Pub. No.: US 2018/0132494 A1
(43) Pub. Date: May 17, 2018

(54) Syrup Coated Pita Chip

(71) Applicant: Regina Ragonesse, Haverhill, MA (US)

(72) Inventor: Regina Ragonesse, Haverhill, MA (US)

(21) Appl. No.: 15/353,075

(22) Filed: Nov. 16, 2016

(51) Int. Cl. A21D 13/00

(52) U.S. Cl. CPC A21D 13/0003

(57) ABSTRACT

A glazed pita chip and method of producing it are presented herein. A pita chip is coated with a syrup and then is cooked to harden the syrup coating into a glaze. Additional granular food items such as nuts, granola, seeds, and the like may be adhered to the chip by the syrup and, once cooked, the glaze.

### BACKGROUND OF THE INVENTION

### Field of the Invention

The present invention relates generally to chip items. More particularly the present invention relates to a syrup coated pita chip.

### Description of Related Art

Pita chips and other similar food items are common snacks. In some cases, such chips may even be seasoned with a granular or powdered food item such as salt, seasoning blends, herbs, spices, and the like. These foods are sufficient in many cases but often suffer from a boring repetitiveness. Currently, no food items are presented that coat the chips with a coating of flavoring glaze on the chips.

Therefore, what is needed is a glazed pita chip food item that provides a sugar based coating over the crispy pita chip.

### SUMMARY OF THE INVENTION

The subject matter of this application may involve, in some cases, interrelated products, alternative solutions to a particular problem, and/or a plurality of different uses of a single system or article.

In one aspect, a method of producing a food item is provided. The method may begin with coating a pita chip with a sugar-based syrup. The syrup is selected to bind to the pita chip. Next, the syrup-coated pita chip may be baked at a relatively low temperature to harden the syrup into a glaze, without extensive or substantial caramelization or burning of the glaze. The pita chips having the glaze coating may then be left to cool. Once cooled, this glaze may be formed as a separate and distinct layer from the pita chip. In some cases, a portion of the glaze is bonded with the chip, forming a chip layer, a combination chip and glaze layer, and a glaze layer. In further embodiments, the syrup-coated chip, before the baking step, may be coated with a granular food material. The granular food material adheres to the syrup coated chip, and remains adhered to the glazed chip after the baking step.

In a particular embodiment, the syrup may comprise a quantity of sugar, a quantity of water, a quantity of butter, and a quantity of baking soda. It has been observed that the combination of appropriate quantities of butter, baking soda, and a sugar based syrup, such as the plant based syrups discussed below, provides the appropriate glaze consistency to fully cover the pita chips that can also bind granular material to the pita chips.

In another aspect, a method for producing a glazed pita chip food item is provided. The method may begin with obtaining a quantity of pita bread dough. The dough may then be baked to form pita bread. The pita bread may be cut into a plurality of pieces. These plurality of pieces are then cooked in an oil to form a plurality of pita chips. After cooking, the plurality of pita chips are coated with a sugar based syrup. These coated pita chips may be baked, hardening the syrup into a glaze. The pita chips having the glaze coating may then be left to cool.

### BRIEF DESCRIPTION OF THE DRAWINGS

FIG. 1 provides a view of an embodiment of a syrup coated pita chip having the syrup hardened on an exterior of the chip.

FIG. 2 provides a view of another embodiment of a syrup coated pita chip having the syrup hardened on an exterior of the chip and holding a granular edible material to the chip.

FIG. 3 provides a flow chart of one embodiment of preparation of the present invention.

FIG. 4 provides a flow chart of another embodiment of preparation of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a syrup coated pita chip. The syrup is cooked onto the pita chip to form a glaze fully or at least partially covering the pita chip. The glaze contemplated herein differs from a granular sugar grain coating or dusting in many ways, namely, the glaze is formed from a liquid syrup and results in a coating, as opposed to a granular material such as sugar coating or dusting. The present invention provides a pleasant and desirable contrast in flavors between the savory pita chip and its sweet glazed coating.

The pita chip contemplated herein may be any sort of crispy rigid chip formed from a pita bread. Such chips may be formed in any cooking manner from a cooked pita bread. Examples of cooking methods to create the chips may include, but are not limited to: frying, deep frying, kettle cooking, baking, and the like. In other alternative embodiments, other chips (such as potato, vegetable, tortilla, corn, flour, and the like) may be used as the base chip to be coated. In such embodiments, these chips may be replaced with the pita chip and treated as discussed throughout the specification.

The syrup coated chip is formed generally by coating an existing pita chip with a syrup, and then baking this syrup covered chip so that the syrup hardens and solidifies while bonded or attached to the chip. The term “syrup” is used herein to refer to the liquid phase of the coating material, the term “glaze” is used herein to refer to the syrup once applied to the pita chips and hardened to a brittle and crisp glaze material after a baking step.

In one particular embodiment, the invention is produced by first baking a pita bread. Once this bread is baked, it may be cut into pieces and then cooked in the presence of a fat and/or oil (such as kettle cooking, baking, frying, deep frying, and the like). After this stage, the resulting product is a pita chip.

Once the pita chip is formed, a syrup may be applied and may coat the outer surface of the chip. The coated chip may then be baked to harden the syrup into a glaze.

The syrup may be coated or applied on the pita chip in any manner. Non-limiting examples of syrup application may include, but are not limited to: submerging the chip in a quantity of syrup, spraying the syrup onto the chip, tossing the chips in the syrup, brushing the syrup onto the chip, drizzling the syrup onto the chip, and the like.

In certain embodiments, a granular food item may also be added which adheres to and is held in place by the syrup and glaze. Examples of granular food items that may be adhered to the chip using the syrup/glaze include, but are not limited to nuts, dried fruit pieces, seeds, granola, trail mix, grains, chocolate, candy, protein powder, spices or spice blends, and the like.

In one embodiment, the syrup may comprise a quantity of butter, sugar, corn syrup, baking soda, vanilla, and salt. In another embodiment, the syrup may comprise a quantity of butter, a quantity of rice (brown, etc.) syrup (which has a lower sugar content than many similar syrups) and/or tapioca syrup, a quantity of vanilla, and a quantity of spices. In some embodiments, the syrup may comprise a quantity of milk (which may be animal milk, plant based milk such as almond milk, cream, or the like). It is to be understood that any material may be used to provide a glaze for the pita chip so long as it contains a quantity of sugar capable of being coated on in a liquid form and baked into a solid form. Generally, the term syrup, or sugar-based syrup is used to refer to a liquid and/or suspension that contains a high amount of sugar, including but not limited to saturated and super saturated liquids. In many embodiments, corn, rice, and/or tapioca syrup, or other similar syrup in combination with corn starch or baking soda has been shown to yield optimal glaze consistency, to allow binding to the pita chip, and to securely bind to the granular food items, holding them to the pita chip (in certain embodiments). While a sugar syrup is the most commonly contemplated embodiment discussed herein, it is also possible to achieve a similar syrup and glaze material using a protein based syrup solution that uses proteins instead of sugar as the thickening and hardening agent.

In varying embodiments, the syrup may further comprise additional flavoring or seasoning. For example, a fruit flavored syrup may be used, a maple flavored syrup, spiced syrup, and the like.

In the varying syrup embodiments, the different components are mixed together and then heated, typically to a boil, to dissolve any soluble materials and to encourage even distribution of any non-soluble materials.

In a particular process embodiment, the pita bread may either be baked from dough, or purchased from an outside vendor. The pita bread may be cut or otherwise broken up into smaller pieces. These pieces are then cooked in oil to crisp them and convert them into pita chips. The chips may be seasoned, or not. This seasoning may occur either after the chips are formed from the pita bread, after the chips are coated with syrup, or after the glazed chips are removed from the breaking step (as discussed in detail below). The chips may then be coated with an embodiment of the syrup such as those discussed above. Optionally, the granular food item may be added to coat or be adhered to the syrup and chip.

The coated chips may be baked at a relatively low temperature such as 250 degrees F. for a time of approximately one hour. This temperature encourages the water in the syrup to evaporate, but does not excessively burn the syrup or disrupt the consistency of the pita chip. In a particular embodiment, the chips may be tossed or otherwise agitated throughout the baking process. Once the baking process has completed, the chips having the glaze may be cooled. In some cases, the chips may group together and the glaze may bind the chips together. In such a case, an additional step of breaking up the bound chips may be performed to yield smaller chip and glaze pieces.

The present invention may be produced using equipment on various scales. For example, on a small scale production, traditional kitchen items and equipment may be used. On a manufacturing scale production, specialized equipment may be utilized to optimize the process. It should be understood that any equipment may be used in varying embodiments without straying from the scope of the present invention.

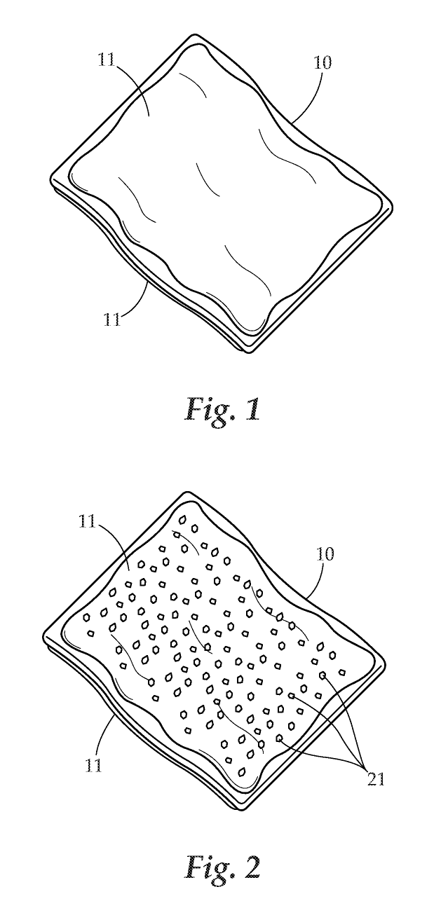

Turning now to FIG. 1, and embodiment of a pita chip of the present invention is provided. In this embodiment, pita chip 10 is coated with a glaze 11. The glaze 11 is formed after the pita chip is coated with a sugar-based syrup and baked, forming a hardened sugar-based crust. The term sugar is used herein to refer to natural sweeteners including, but not limited to sucrose, glucose, fructose, and the like.

FIG. 2 provides another embodiment of a pita chip of the present invention. In this view, the pita chip 10 is coated with a glaze 11. A granular food material 21 is attached to the pita chip 10 by the glaze 11. In varying embodiments, glazes that have higher binding ability may comprise quantities of corn starch and corn/rice/tapioca or other plant based syrup. Other plant based syrups may include, but are not limited to: honey, molasses, date syrup, coconut based sugar syrups, and the like. However, it should be understood that the binding syrup/glaze 11 may be formed of any number of materials so long as it can bind the granular food material 21 to the pita chip 10.

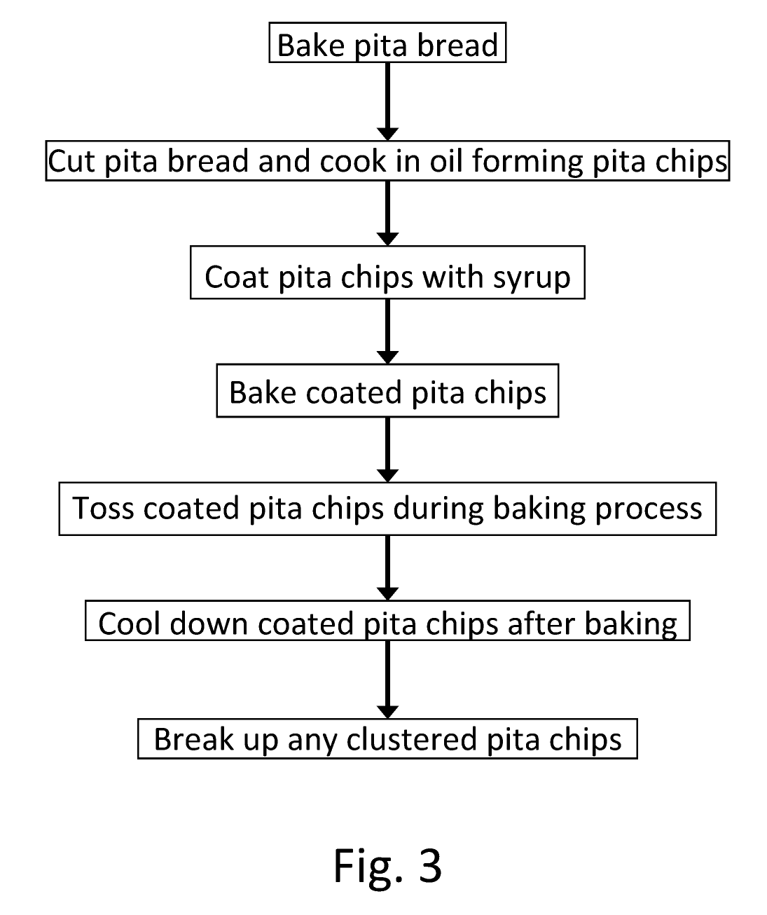

FIG. 3 shows a flow chart of one embodiment of the present invention. In this embodiment, the process begins with baking pita bread from dough to create the bread (which is known to be soft and flexible). Once the bread is baked, it is cut into pieces and cooked in oil. This cooking may include, but is not limited to: frying, deep frying, kettle cooking, baking, and the like. Once the cooking process is finished, the pita bread pieces are now pita chips. Next, the pita chips may be coated with a sugar syrup. The coated pita chips may then be baked at a moderately low temperature (for example 250 degrees Fahrenheit) for approximately one hour (though time and temperature may vary). During the baking process, the coated pita chips may be tossed or otherwise agitated to facilitate even cooking and crispness of the glaze formed by the cooking syrup. In a particular embodiment, the tossing may be performed every twenty minutes. Once the baking process is completed, the coated pita chips are allowed to cool. Further, if any chips have clustered together because of a stickiness of the syrup, the clusters may be broken up to form smaller pieces.

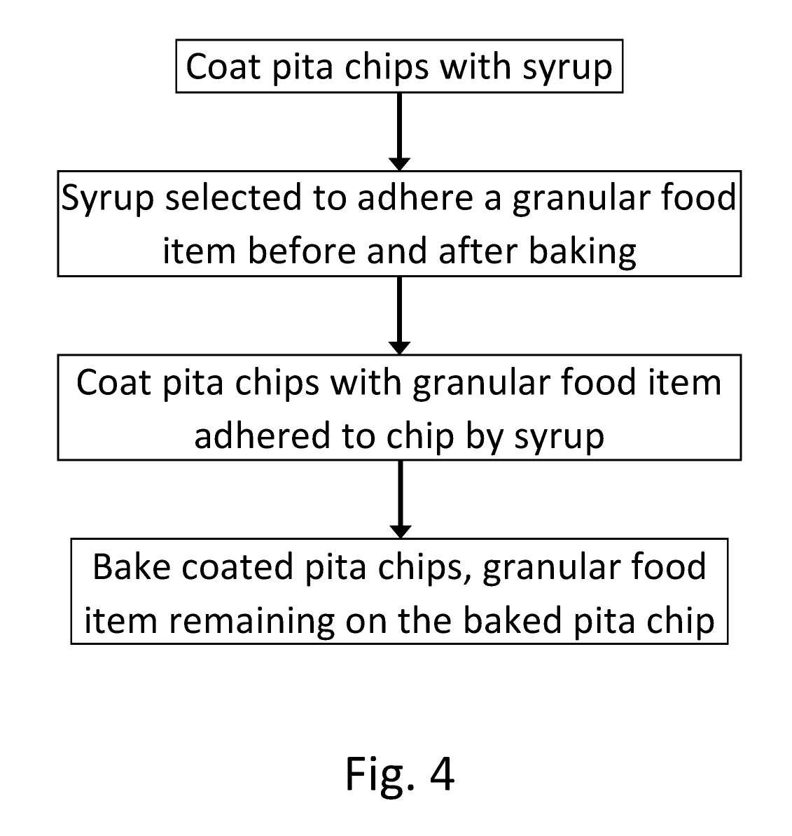

FIG. 4 provides a flow chart of another embodiment of the present invention. In this embodiment, pita chips are initially coated with a sugar-based syrup. The syrup selected is sugar based and is configured to adhere a granular food item to the pita chip both before (when a liquid syrup) and after baking (when a hardened glaze). The syrup-coated pita chips may next be coated, dredged, or otherwise exposed to a granular food item. The syrup, as noted, is selected to adhere the granular food item to the pita chip. The combination food item (pita, syrup, granular food item) is then baked for a time period sufficient to solidify the syrup into glaze that retains the granular food item on the pita chip.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A method of producing a food item comprising the steps of:
coating a pita chip with a sugar-based syrup;
baking the coated pita chip, hardening the syrup into a glaze; and
cooling the glazed pita chip.

2. The method of claim 1 further comprising the step of coating the syrup coated pita chip with a granular food material before the baking of the coated pita chip, the granular food material sticking to the syrup.

3. The method of claim 1 wherein the syrup comprises: a quantity of sugar, a quantity of water, a quantity of butter, and a quantity of baking soda.

4. The method of claim 1 wherein:
the step of baking the coated pita chip comprises baking at approximately 250 degrees for one hour; and
further comprising the step of tossing the coated pita chips during the baking process.

5. The method of claim 1 wherein the syrup comprises: a quantity of butter, a quantity of sugar, a quantity of at least one of a corn syrup, rice syrup, and tapioca syrup, a quantity of baking soda, a quantity of vanilla, and a quantity of salt.

6. The method of claim 5 further comprising the step of breaking up a cluster of a plurality of pita chips joined together by the glaze, the breaking up separating the pita chip cluster into single pita chip pieces.

7. The method of claim 6 wherein the granular food material is at least one of nuts, dried fruit pieces, seeds, granola, trail mix, grains, protein powder, chocolate pieces, spices, spice blends, and candy.

8. A method of producing a food item comprising the steps of:
obtaining a quantity of pita bread dough;
baking the quantity of pita-bread dough forming pita bread;
cutting the pita bread into a plurality of pieces;
cooking the plurality of pieces in a fat or an oil forming pita chips;
coating each of the plurality of pita chips with a sugar-based syrup;
baking the plurality of coated pita chips, hardening the syrup into a glaze; and
cooling the plurality of glazed pita chips.

9. The method of claim 8 further comprising the step of coating the plurality of syrup coated pita chips with a granular food material before the baking of the coated pita chip, the granular food material sticking to the syrup.

10. The method of claim 9 wherein the syrup comprises: a quantity of sugar, a quantity of water, a quantity of butter, and a quantity of baking soda, the quantity of sugar and the quantity of baking soda sufficient to adhere the granular food material both before baking, and after baking when the syrup is a glaze.

11. The method of claim 9 wherein the granular food material is at least one of nuts, dried fruit pieces, seeds, granola, trail mix, grains, chocolate, and candy.

12. The method of claim 8 further comprising the step of tossing the plurality of coated pita chips during the baking step.

13. The method of claim 8 wherein the syrup comprises: a quantity of butter, a quantity of sugar, a quantity of at least one of a corn syrup, rice syrup, and tapioca syrup, a quantity of baking soda, a quantity of vanilla, and a quantity of salt.

14. The method of claim 13 wherein the syrup further comprises a quantity of milk.

15. The method of claim 8 wherein:
the step of baking the plurality of coated pita chips comprises baking at approximately 250 degrees for one hour.

16. The method of claim 15 further comprising the step of tossing the plurality of coated pita chips during the baking process.

17. The method of claim 8 wherein the coating step comprises fully submerging the pita chip into the syrup and removing the pita chip from the syrup.

18. The method of claim 8 wherein the coating step comprises spraying the syrup onto the pita chip.

19. The method of claim 8 wherein the coating step comprises brushing the syrup onto the pita chip.

20. The method of claim 8 further comprising the step of breaking up a cluster of a plurality of pita chips joined together by the glaze, the breaking up separating the pita chip cluster into single pita chip pieces.
